(19) United States
(12) Patent Application Publication
(10) Pub. No.: US 2015/0163610 A1
(43) Pub. Date: Jun. 11, 2015

(54) AUDIO KEYWORD BASED CONTROL OF MEDIA OUTPUT

(71) Applicant: QUALCOMM Incorporated, San Diego, CA (US)

(72) Inventors: Kuntal Dilipsinh Sampat, San Diego, CA (US); KeeHyun Park, San Diego, CA (US)

(73) Assignee: QUALCOMM Incorporated, San Diego, CA (US)

(21) Appl. No.: 14/103,163

(22) Filed: Dec. 11, 2013

(51) Int. Cl. H04R 29/00; G10L 17/22

(52) U.S. Cl. CPC H04R 29/00; G10L 17/22

(57) ABSTRACT

A method includes receiving, at a communication device, audio data from a second device. The method further includes playing audio output, the audio output derived from the audio data. The method further includes switching from playing the audio output to generating media output from a source other than the second device while monitoring the audio data for a keyword. The method further includes switching back to playing the audio output based on detecting the keyword.

### I. FIELD

The present disclosure is generally related to monitoring audio data.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), tablet computers, and paging devices that are small, lightweight, and easily carried by users. Many such computing devices include other devices that are incorporated therein. For example, a wireless telephone can also include a digital still camera, a digital video camera, a digital recorder, and an audio file player. Also, such computing devices can process executable instructions, including software applications, such as a web browser application that can be used to access the Internet and multimedia applications that utilize a still or video camera and provide multimedia playback functionality.

Computing devices, such as wireless telephones, may be used to call users of other computing devices. During a call a user may be placed on hold. Sometimes a hold may last for a long period of time. Some systems may play music for the user to listen to while on hold, but the music may not be to the user's liking. Because the user monitors the call for the end of the hold, the user may be unable to engage in other activities, such as using a camera, a software application, or a multimedia application of the computing device.

### III. SUMMARY

The present disclosure may enable presentation of alternative media content by a communication device while a user is placed on hold during a call. The communication device may monitor the call for a keyword indicating the hold has ended and, when the hold has ended, cease presenting the alternative media content and resume presenting the call to the user.

In a particular embodiment, a method includes receiving, at a communication device, audio data from a second device. The method further includes playing audio output, the audio output derived from the audio data. The method further includes switching from playing the audio output to generating a media output from a source other than the second device while monitoring the audio data for a keyword. The method further includes switching back to playing the audio output based on detecting the keyword.

In another embodiment, an apparatus includes a memory and a processor. The processor is configured to receive data from a second device. The processor is further configured to play output, the output derived from the data. The processor is further configured to switch from playing the output to generating media output from a source other than the second device while monitoring the data for a keyword. The processor is further configured to switch back to playing the output based on detecting the keyword.

In another embodiment, a computer-readable medium includes instructions, which when executed by a processor cause the processor to receive audio data from a second device. The instructions further cause the processor to play audio output, the audio output derived from the audio data. The instructions further cause the processor switch from playing the audio output to generating media output from a source other than the second device while monitoring the audio data for a keyword. The instructions further cause the processor to, switch back to playing the audio data based on detecting the keyword.

### IV. BRIEF DESCRIPTION OF THE DRAWINGS

FIG. 1 is a block diagram that illustrates a particular embodiment of a system that is operable to monitor audio data;

FIG. 2 is a block diagram that illustrates another embodiment of a system that is operable to monitor audio data;

FIG. 3 is a diagram of a graphical user interface (GUI) used in monitoring audio data;

FIG. 4 is a diagram of another GUI used in monitoring audio data;

FIG. 5 is a diagram of another GUI used in monitoring audio data;

FIG. 6 is a flow chart that illustrates a particular embodiment of a method of monitoring audio data; and

FIG. 7 is a block diagram illustrating a particular embodiment of a communication device configured to monitor audio data.

### V. DETAILED DESCRIPTION

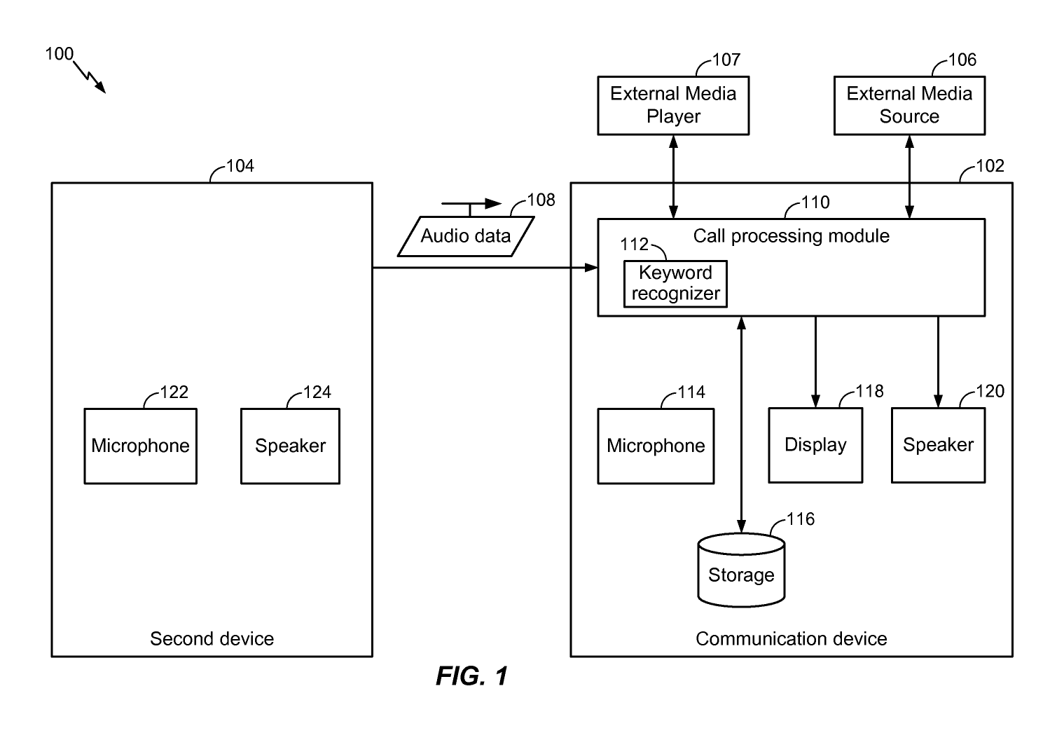

Referring to FIG. 1, a system 100 for monitoring audio data is shown. The system 100 includes a communication device 102. The communication device 102 may include a smart phone, tablet computer, or a personal computer. The communication device 102 includes a call processing module 110, a microphone 114, a data storage device 116, a display 118, and a speaker 120. The call processing module 110 includes a keyword recognizer 112. The keyword recognizer 112 may be capable of processing voice data to identify words. The data storage device 116 may include a flash memory, a hard disk, or any other type of storage device capable of storing digital information. The display 118 may include a display interface such as a touch screen, a liquid crystal display, any other type of display, or any combination thereof. The speaker 120 may correspond to an audio interface capable of producing sounds based on signals. In some embodiments, the microphone 114, the display 118, the speaker 120, or any combination thereof may be devices distinct from and in communication with the communication device 102.

The communication device 102 may be configured to communicate with a second device 104 (e.g., via a voice data session or a telephone call). The second device 104 may include a smart phone, a telephone, a tablet computer, a personal computer, or any other communication device capable of transmitting voice data. The second device 104 includes a microphone 122 and a speaker 124.

The communication device 102 may further be configured to communicate with an external media source 106. The external media source 106 may be any system or device capable of delivering media content to the communication device 102. As used herein, media content may refer to music, applications, video, video games, images, web pages, other media, or any combination thereof. In some embodiments, the external media source 106 includes a storage device, such as an external hard drive or a media server on a network storing media content. In other embodiments, the external media source 106 is a web service that provides media content, such as a website that provides streams of music or video. Media content may include applications that control hardware of the communication device 102 or devices external to the communication device 102. For example, an application may include a camera function that controls a camera of the communication device 102.

The communication device 102 may additionally or in the alternative be configured to communicate with an external media player 107. The external media player 107 may be a device capable of playing media content (e.g., a third electronic device). For example, the external media player 107 may be a television, a personal computer, a tablet computer, a digital video disk (DVD) player, or a video game console. The external media player 107 may receive media content from the communication device 102 and may generate output (e.g., sound and/or video display) based on the media content.

In operation, the communication device 102 may receive audio data 108 from the second device 104. The audio data 108 may correspond to speech received at the microphone 122 during a call between the communication device 102 and the second device 104. The call may be a voice-only call or a voice and video call. In particular embodiments, the communication device 102 may generate media output before the call begins via the speaker 120, the display 118, the external media player 107, or a combination thereof. For example, the display 118 may be showing visual media content and/or the speaker 120 may be playing aural media content. The media content may be retrieved from the data storage device 116 or received from the external media source 106. In a particular embodiment, the external media player 107 may generate media output independently of the communication device 102. For example, the external media player 107 may correspond to a television. The television may play television content before the call begins.

When the call begins and the communication device 102 receives the audio data 108, the call processing module 110 may halt the generation of the media output via the display 118, the speaker 120, the external media player 107, or a combination thereof and begin generating audio output derived from the audio data 108 at the speaker 120, the external media player 107, or a combination thereof. For example, the call processing module 110 may halt output of visual media content and/or the aural media content and may cause the speaker 120 to output audio output corresponding to speech received at the microphone 122. In embodiments in which the external media player 107 generates media output independently of the communication device 102, the call processing module 110 may send a request to halt media output to the external media player 107. In some embodiments, the communication device 102 may not generate media output before the call.

During the call, a user of the second device 104 may place a user of the communication device 102 on hold. In response to being placed on hold, the communication device 102 may enter a monitor hold mode. The communication device 102 may detect the hold automatically or the user of the communication device 102 may manually cause the communication device 102 to enter into the monitor hold mode. For example, the keyword recognizer 112 of the call processing module 110 may detect the word “hold” in the audio data 108 and enter the monitor hold mode, after a pre-determined time. Alternatively, the user of the communication device 102 may select an option presented in a graphical user interface (GUI) corresponding to the monitor hold mode. In a particular embodiment, the call processing module 110 corresponds to an application and a user manually enters a command to execute the application in response to being placed on hold. The application may automatically enter the monitor hold mode upon execution.

In the monitor hold mode, the call processing module 110 may use the keyword recognizer 112 to monitor the audio data 108 for a keyword. The keyword may indicate that the hold has ended. Monitoring the audio data 108 for the end of the hold may enable the call processing module 110 to generate media output unrelated to the audio data 108 during the hold and automatically switch back to generating audio output based on the audio data 108 when the hold ends.

Upon entering the monitor hold mode, the call processing module 110 may cause the communication device 102 to generate media output via the display 118, the speaker 120, the external media player 107, or a combination thereof. The media output may be based on user activity prior to the call (e.g., the media output generated before the call). For example, the communication device 102 may have been playing a movie via the display 118 and the speaker 120 before the call. When the call began, the call processing module 110 may have paused playback of the movie or muted the movie and may have begun generating audio output based on the received audio data 108. When the communication device 102 is placed on hold, the call processing module 110 may enter the monitor hold mode and resume playback of the movie or unmute the movie. Alternatively, the generated media output may correspond to media content stored in the data storage device 116 or media content received from the external media source 106. The media content used to generate the media output may be selected by the user of the communication device 102 prior to or upon entering the monitor hold mode. It should be noted that while the data storage device 116 and the external media source 106 are shown, in particular embodiments, the media output may be derived from media content received from any source other than the second device 104. In embodiments in which the external media player 107 independently generates media output, the call processing module 110 may send a request to the external media player 107 to resume or to begin generating media output in response to entering the monitor hold mode.

While generating the media output in the monitor hold mode, the call processing module 110 monitors the audio data 108 using the keyword recognizer 112 to monitor for at least one keyword. The keyword may indicate that the hold is over and may correspond to a default keyword, such as “hello.” In addition or in the alternative, the keyword may include keywords chosen based on user input or keywords chosen based on a detected language or location. In a particular embodiment, the keyword may include a name of an owner of the communication device 102. The name of the owner may be detected automatically based on settings of the communication device 102 or based on an analysis of words detected by the keyword recognizer 112 in the audio data 108. Based on the keyword recognizer 112 detecting the keyword, the call processing module 110 may halt generation of the media output and resume generation of the audio output based on the audio data 108.

For example, the keyword recognizer 112 may detect a keyword (e.g., “hello”) in the audio data 108 indicating that the user of the second device 104 is speaking and the communication device 102 is no longer on hold. In response to detecting the keyword, the call processing module 110 may pause, mute, or otherwise cease presenting the media output via the display 118 and/or the speaker 120 and resume presentation of the audio output based on the audio data 108.

The call may continue for a time before coming to an end. Upon determining that the call has ended, the call processing module 110 may resume generation of the media output. For example, the call processing module 110 may receive a message indicating that the call has ended or may detect that no voice data has been received for a threshold amount of time. In response to the determination, the call processing module 110 may resume generating media output or may allow a user to initiate generation of media output. For example, the call processing module 110 may present a GUI enabling the user to initiate media output. In addition or in the alternative, the call processing module 110 may adjust settings of the communication device 102 (e.g., enable processes associated with media output, such as music or video players, to access the display 118 and/or the speaker 120).

In another embodiment, the external media player 107 may be generating media output when the call begins. The media output may be based on media content stored in the data storage device 116, at the external media player 107, or at any other device, such as the external media source 106. When the call begins, the call processing module 110 may cause the external media player 107 to stop outputting the media output and may generate audio output based on the audio data 108. The audio output may be played at the external media player 107, at the speaker 120, or a combination thereof.

In particular embodiments, the call processing module 110 may generate media output by causing the external media player 107 to resume outputting media (e.g., by unmuting or by turning on the external media player 107). Similarly, the call processing module 110 may halt generation of the media output by causing the external media player 107 to cease outputting media (e.g., by muting or by turning off the external media player 107).

While the above disclosure describes audio and video media content, in particular embodiments, generating media output may correspond to executing an application at the communication device 102. For example, the application may be a text messaging application enabling the user of the communication device 102 to send text messages and review received text messages. As another example, the application may correspond to a camera application enabling the user to take still pictures or record video. Further, the application may correspond to a web browser, a video game, or an e-mail client.

Thus, the system 100 may enable a user to enjoy media content other than that provided in the audio data 108 while on hold. Furthermore, the user of the communication device 102 may enjoy the media content without listening for an end of the hold. Thus, the communication device 102 may improve the user experience when being placed on hold.

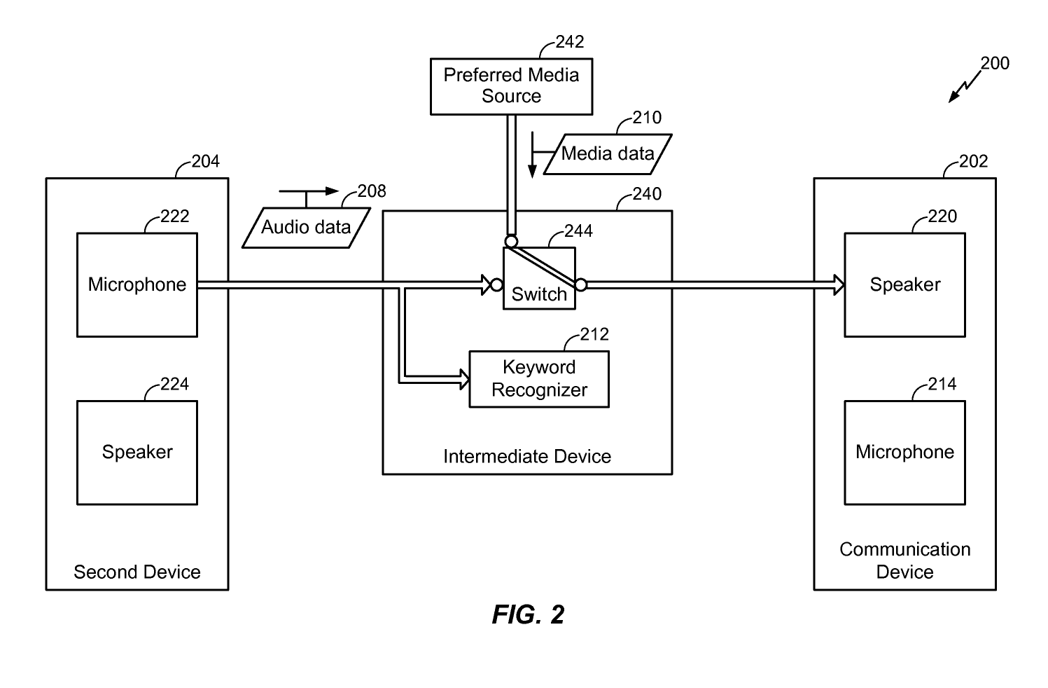

In alternate embodiments, some or all of the functions of the call processing module 110 may be performed by an intermediate device. Referring to FIG. 2, a system 200 of monitoring audio data using an intermediate device is shown. The system 200 includes a communication device 202, an intermediate device 240, and a preferred media source 242.

The communication device 202 includes a speaker 220 and a microphone 214. The communication device 202 is configured to communicate with a second device 204 via the intermediate device 240. The second device 204 includes a microphone 222 and a speaker 224. The intermediate device 240 may be directly connected to the communication device 202 (e.g., may be a residential gateway used by the communication device 202) or may be connected to the communication device 202 via a network. The intermediate device 240 includes a keyword recognizer 212 and a switch 244. The intermediate device 240 may perform one or more functions of the call processing module 110 of FIG. 1 for the communication device 202. The intermediate device 240 may be configured to communicate with the preferred media source 242. The preferred media source 242 provides media data 210 to the intermediate device 240. The preferred media source 242 may be selected by a user of the communication device 202. For example, the communication device 202 may transmit a selection of the preferred media source 242 to the intermediate device 240. The selection may also include a selection of media content used to generate the media data 210. Alternatively, the communication device 202 may transmit a second selection identifying the media content. The selection or selections may be based on user input received via a GUI displayed at the communication device 202. Alternatively, the selection or selections may be based on user input received via an audio interface. The preferred media source 242 may include a media streaming service, a media storage device, a third communication device, or any combination thereof. In particular embodiments, the preferred media source 242 may be any source other than the second communication device 204.

In operation, the second device 204 sends audio data 208 corresponding to sounds detected at the microphone 222 to the communication device 202 via the intermediate device 240. The communication device 202 generates audio output at the speaker 220 corresponding to the audio data 208. When the communication device 202 is placed on hold by a user of the second device 204, the intermediate device 240 enters a monitor hold mode. The intermediate device 240 may detect the hold automatically by monitoring the audio data 208 using the keyword recognizer 212 for a particular word or words (e.g., “hold”) indicating the hold. Alternatively, the intermediate device 240 may receive a message (e.g., from the communication device 202) indicating the hold. For example, a user of the communication device 202 may select an option (e.g., via a GUI, such as the GUI 300 described below, or via a voice command recognized by the keyword recognizer 212) to enter the monitor hold mode at the communication device 202. The communication device 202 may transmit a message to the intermediate device 240 indicating the selection.

In the monitor hold mode, the switch 244 interrupts communications between the communication device 202 and the second device 204 and connects the preferred media source 242 to the communication device 202 so that the audio data 208 received by the communication device 202 includes media content. Alternatively, the intermediate device 240 may modify the audio data 208 by replacing a portion of the audio data 208 with the media data 210. Thus, the audio output generated by the speaker 220 includes media content from the preferred media source 242. The preferred media source 242 may be selected by the user of the communication device 202. In particular embodiments, the media content may be video or image content and a message may be sent to the communication device 202 to output the video or image content using a display (not shown).

While in the monitor hold mode, the intermediate device 240 keeps a session or connection to the second device 204 open to receive the audio data 208. The keyword recognizer 212 monitors the audio data 208 for at least one keyword. In response to detecting a keyword, the keyword recognizer 212 causes the switch 244 to disconnect the preferred media source 242 from the communication device 202 and to connect the second device 204 to the communication device 202. Thus, the communication device 202 receives the audio data 208 from the second device 204 after the keyword is detected and generates audio output based on the audio data 208.

In another embodiment, the switch 244 is part of the communication device 202 and the keyword recognizer 212 is part of the intermediate device 240. In this embodiment, the keyword recognizer 212 transmits a message to the switch 244 indicating that a keyword has been detected. In response to the message, the switch 244 may cause the communication device 202 to switch from generating media output based on the media data 210 to generating audio output based on the audio data 208.

In another embodiment, the preferred media source 242 may be a part of the communication device 202. When the preferred media source 242 is a part of the communication device 202, the switch 244 of the intermediate device 240 may send control signals to the communication device 202 to cause the communication device 202 to switch from generating media output based on the media data 210 to generating audio output based on the audio data 208. In this way, the switch 244 may operate by transmitting a message to the communication device 202 indicating that the communication device 202 should begin or halt media output.

Thus, the system 200 may enable a user of the communication device 202 to enjoy media content, such as movies or music, selected by the user while on hold. The user may enjoy the media content without worrying about listening for a call hold to end. The communication device 202 may begin outputting the call automatically upon the hold ending.

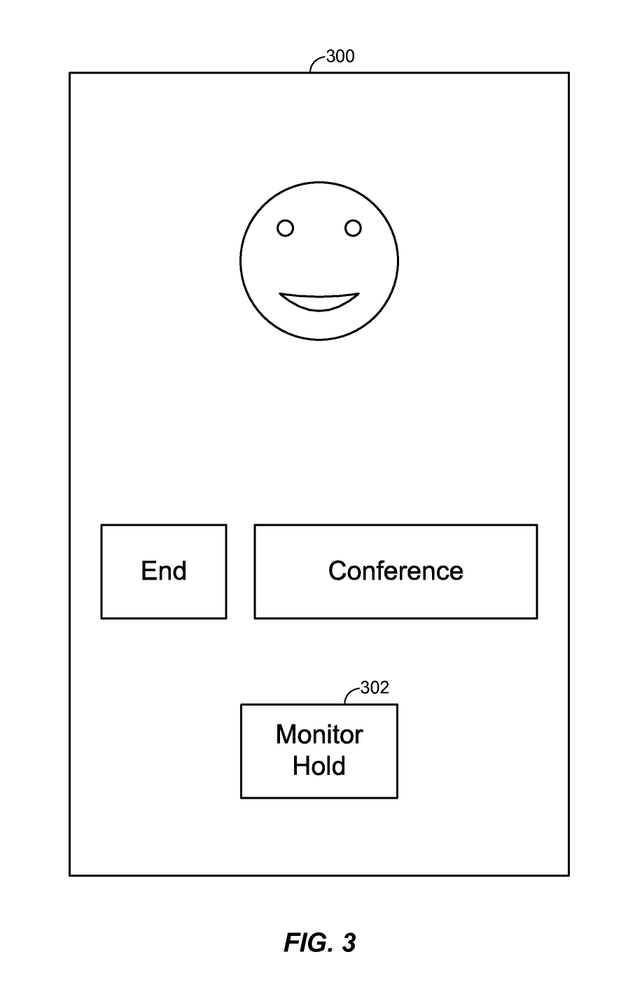

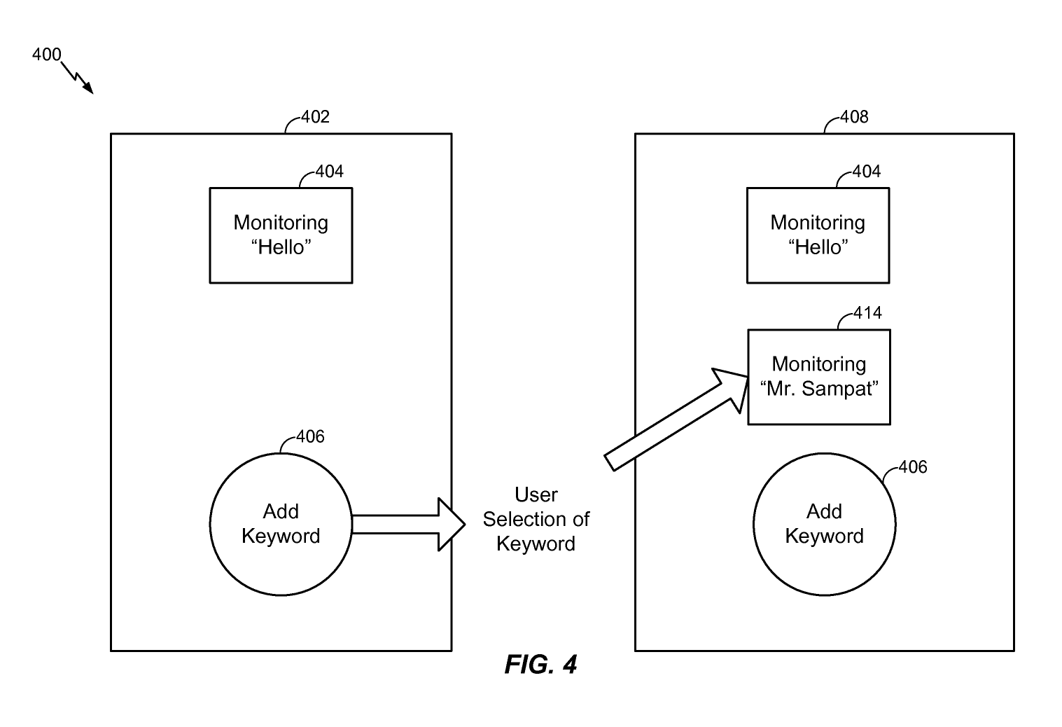

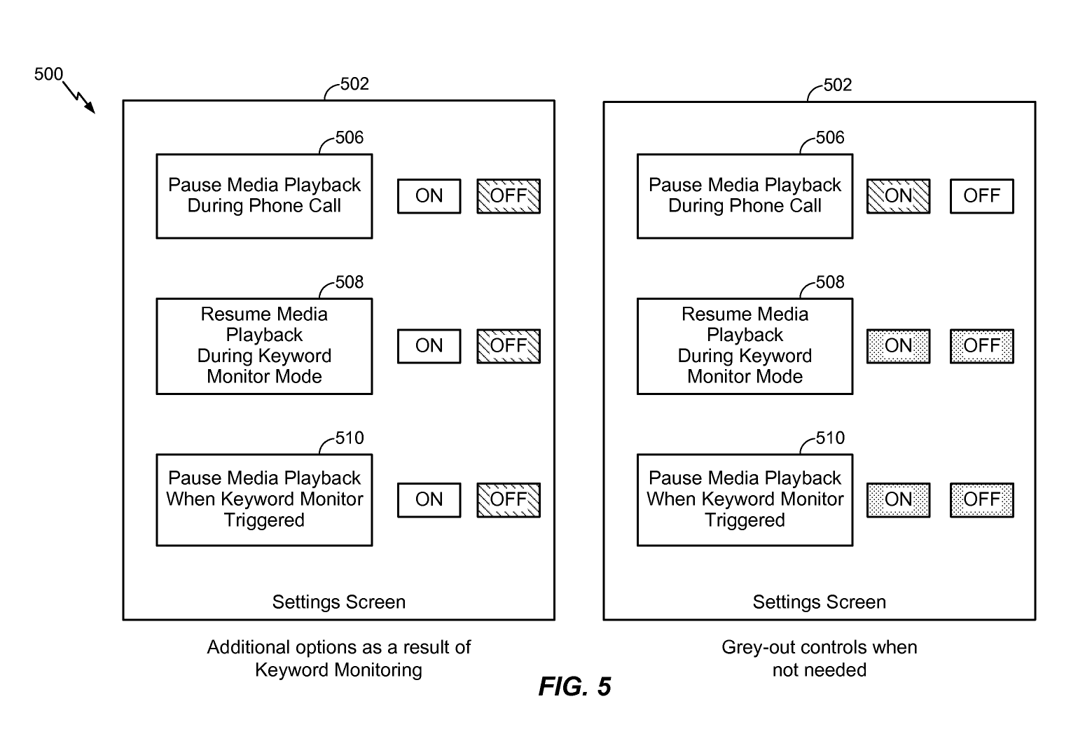

Referring to FIG. 3 a diagram of a GUI 300 for activating a monitor hold mode is shown. In particular embodiments, a user may interact with the GUI via a touch screen interface, voice commands, a mouse, gestures, a keyboard, or any combination thereof. The GUI 300 may be presented during a phone call by the communication device 102 of FIG. 1 or by the communication device 202 of FIG. 2. The GUI 300 includes a plurality of selectable options including a monitor hold option 302. While only three options are shown, fewer or more options (e.g., options related to the call) may be displayed. Selection of the monitor hold option 302 may cause a communication device to enter a monitor hold mode as described in reference to FIGS. 1 and 2. Upon entering the monitor hold mode, the communication device may display a new GUI including options to select media content to generate media output. The options may correspond to icons associated with various applications (e.g., a text messaging application, an e-mail application, a music application, a video application, a camera application, a video game application, etc.) The new GUI may include an option to exit the monitor hold mode and/or an option to return to the GUI 300. Alternatively, the selection may cause display of a monitor hold settings GUI (e.g., the GUI of FIG. 4 or the GUI of FIG. 5).

Thus, the GUI 300 of FIG. 3 may enable a user to activate a monitor hold mode, as described in FIGS. 1 and 2, causing a communication device or an intermediate device to monitor a call for an end to a hold while generating media output. A user may use the monitor hold function to enjoy alternative media content, such as music, movies, or an application (e.g., a video games, a camera application, an e-mail application, a text messaging application, etc.) selected by the user while on hold without listening for the end of the hold.

Referring to FIG. 4, a diagram of a GUI 400 for changing keywords to monitor is shown. The GUI 400 may be used by the communication device 102 of FIG. 1 or the communication device 202 of FIG. 2 to add monitored keywords to the call processing module 110 or the intermediate device 240 to be monitored during a monitor hold mode. In particular embodiments, a user may interact with the GUI 400 via a touch screen interface, voice commands, a mouse, gestures, a keyboard, or any combination thereof. The GUI 400 may be generated based on words monitored by the call processing module 110. The communication device 202 may update the monitored words based on input received via the GUI 400. Alternatively, the GUI 400 may be generated based on input from an intermediate device such as the intermediate device 240. The communication device 202 may update the words monitored by the intermediate device 240 based on input received via the GUI 400. For example, the communication device 202 may send a message to the intermediate device 240 identifying keywords to add to or remove from the monitored words or including keyword recognition data (such as a voice recording of a particular keyword).

In operation, the GUI 400 may include a first screen 402 indicating monitored words for a monitor hold mode, as described above. The first screen 402 includes an element 404 indicating that audio data will be monitored for the word “hello.” The word “hello” may be a default monitored word. The element 404 may be selectable. Upon receiving a selection of the element 404, the GUI 400 may present an option to remove the word “hello” from the monitored words. The first screen 402 further includes a user selectable option 406 to add a keyword. While an option 406 to add a keyword is shown, the GUI 400 may also include options to modify or remove a keyword. Upon receiving a selection of the option 406, the GUI 400 may prompt a user to input a new keyword. Keywords may comprise one or more words. The new keyword may be input by speaking into a microphone, such as the microphone 114 or the microphone 214, by typing via a keyboard or touch screen interface, or by selection from a list. For example, the user may enter “Mr. Sampat” via text or speech input. “Mr. Sampat” is the name of the device owner, either inferred from the device settings, or from in-call speech recognition when conversation is initiated.

After receipt of the new keyword (e.g., “Mr. Sampat”), the GUI 400 may be updated to include a second screen 408. The second screen 408 includes the element 404 and an element 414 indicating that audio data will be monitored for the keywords “Hello” and “Mr. Sampat,” respectively, when the communication device is in a monitor hold mode.

In particular embodiments, the GUI 400 may be accessed while the communication device is in the monitor hold mode. Thus, a user may add, delete, replace or otherwise update the monitored words while the communication device is in the monitor hold mode. For example, a user may add the phrase “Mr. Sampat” to the monitored words using the GUI 400 while the communication device is in the monitor hold mode and thereafter the communication device monitors audio data for “Mr. Sampat” in addition to the monitored word “hello.”

It should be noted that the GUI 400 may include fewer screens, options, or elements or more screens, options, or elements in particular embodiments than are depicted in FIG. 4.

Thus, the GUI 400 may enable a user to add keywords to be monitored in a monitor hold mode of a system for call processing. Customization of the keywords monitored may increase accuracy of the systems 100 and 200 in determining the end of a hold. Therefore, during a call hold time period, a user of the communication device 102 or the communication device 202 may enjoy alternative media content, such as music or a movie, rather than listening for an end of the hold.

In some embodiments, the list of monitored words may be updated based on other factors. For example, a communication device may alter the monitored words based on a location of a second device in communication with the communication device. The location may be determined based on a country code of a phone number associated with the second device or based on location information received from the second device. In a particular example, the communication device may determine that the second device is located in Spain and update the monitored words (e.g., change “Hello” to “Hola”). The communication device may update the monitored words based on translating each monitored word according to a dictionary stored at the communication device or at another device.

In some particular embodiments, the list of monitored words may be updated based on a detected language. For example, the keyword recognizer 112 or the keyword recognizer 212 may determine that a conversation during a call uses a particular language and may update the list of monitored words accordingly. For example, a keyword recognizer may determine that a telephone call is being conducted at least in part in German and may change the monitored word “Hello” to “Hallo.” Alternatively, the keyword recognizer may add “Hallo” to the list of monitored words. The communication device may update the monitored words based on translating each monitored word according to a dictionary stored at the communication device or at another device.

Referring to FIG. 5, a diagram of a GUI 500 for configuring options related to a monitor hold mode is shown. The GUI 500 may be used by the communication device 102 of FIG. 1 or the communication device 202 of FIG. 2. In particular embodiments, a user may interact with the GUI via a touch screen interface, voice commands, a mouse, gestures, a keyboard, or any combination thereof. The GUI 500 may be used to adjust settings of a call processing module such as the call processing module 110 of FIG. 1, an intermediate device such as the intermediate device 240 of FIG. 2, or a combination thereof.

The GUI 500 includes a screen 502. The screen 502 includes a first option 506, a second option 508, and a third option 510. The first option 506 may enable a user to turn a function to pause playback of media output during a call on or off. For example, when the function to pause during a call is turned on, the call processing module 110 may halt media output at the display 118, the speaker 120, the external media player 107, or a combination thereof when a call begins. When the function to pause during a call is turned off, the call processing module may not halt media output. In particular embodiments, the GUI 500 includes options to configure particular media outputs or devices to halt when a call begins.

The second option 508 may enable a user to turn on or turn off a function to resume playback during monitor mode. When the function to resume is turned on, the call processing module 110 may cause media output at the display 118, the speaker 120, the external media player 107, or a combination thereof, to resume upon entering a monitor mode as described above. When the function to resume is turned off, the call processing module 110 may continue generating audio output based on audio data received during the call. Alternatively, the call processing module 110 may allow the user to select media content to generate media output.

The third option 510 may enable a user to turn on or turn off a function to pause media playback when a keyword monitor is triggered. When the function to pause when the keyword monitor is triggered is turned on, the call processing module 110 may pause media output at the display 118, the speaker 120, the external media player 107, or a combination thereof, and resume generating audio output based on audio data received during the call when the keyword recognizer 112 detects a keyword. When the function to pause when the keyword monitor is triggered is turned off, the call processing module 110 may not halt generation of media output and may resume generating audio output based on audio data received during the call when the keyword recognizer 112 detects a keyword. In a particular embodiment, the second option 508 and the third option 510 are combined into a single option to enable a user to turn on or turn off automated keyword-based media control.

When a particular option such as the first option 506 is turned off, the screen 502 may disable selection of other options. This may be indicated, for example, by “greying out” the disabled options or otherwise indicating that particular options are not selectable.

In particular embodiments, the GUI 500 may be accessed while the communication device is in the monitor hold mode. The GUI 500 may enable configuration settings of the monitor hold mode to be changed while the communication device is in the monitor hold mode. For example, the GUI 500 may receive a selection turning off the third option 510 during the monitor hold mode. When a keyword is detected, the communication device may not halt generation of media output. In some embodiments, turning off the first option 506, the second option 508, or the third option 510 while the communication device is in the monitor hold mode may cause the communication device to exit the monitor hold mode before detecting a keyword.

While examples illustrate functionality of the call processing module 110 of FIG. 1, the GUI 500 may similarly be used to configure the intermediate device 240 of FIG. 2. For example, the communication device 202 may present the GUI 500 and transmit configuration settings to the intermediate device 240 based on selected options. Additionally, the GUI 500 may include fewer screens or options or more screens or options than depicted in FIG. 5. Thus, the GUI 500 may enable a user to configure settings related to a system for call processing. The GUI 500 may enable a user of the communication device 102 or the communication device 202 to enjoy alternative media content, such as music, a movie, or an application (e.g., a video game, a camera application, an e-mail application, a text messaging application, etc.), rather than listening for an end of the hold.

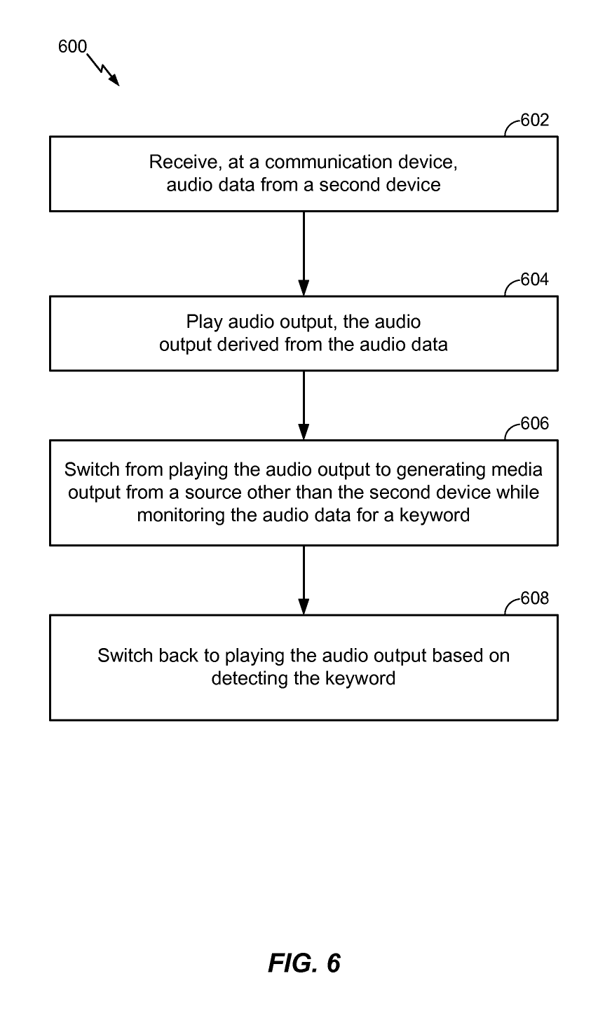

Referring to FIG. 6, a method 600 of call processing is shown. The method 600 includes receiving, at a communication device, audio data from a second device, at 602. For example, the communication device 102 may receive the audio data 108 from the second device 104 during a call.

The method 600 further includes playing audio output derived from the audio data, at 604. For example, the call processing module 110 may cause the speaker 120 to output sounds derived from the audio data 108 corresponding to sounds received by the microphone 122 of the second device 104.

The method 600 further includes switching from playing the audio output to generating media output from a source other than the second device while monitoring the audio data for a keyword, at 606. For example, while the keyword recognizer 112 monitors the audio data for a keyword, the call processing module 110 may halt generating audio output based on the audio data 108 and may begin generating media output. The media output may be based on media content stored at the data storage device 116 or may be received from the external media source 106. The media output may be output via the display 118, the speaker 120, the external media player 107, or a combination thereof.

The method 600 further includes switching back to playing the audio output based on detecting the keyword, at 608. For example, the call processing module 110 may halt media output via the display 118, the speaker 120, the external media player 107, or a combination thereof, and resume outputting audio output based on the audio data 108 at the speaker 120.

Thus, the method 600 may enable presentation of alternative media content to user while the user is on hold during a call and may automatically switch to the call upon detecting that the hold has ended based on keyword recognition. Therefore, a user may listen to or view media content selected by the user instead of waiting for a hold to end and being subjected to media content provided by the party who placed the user on hold.

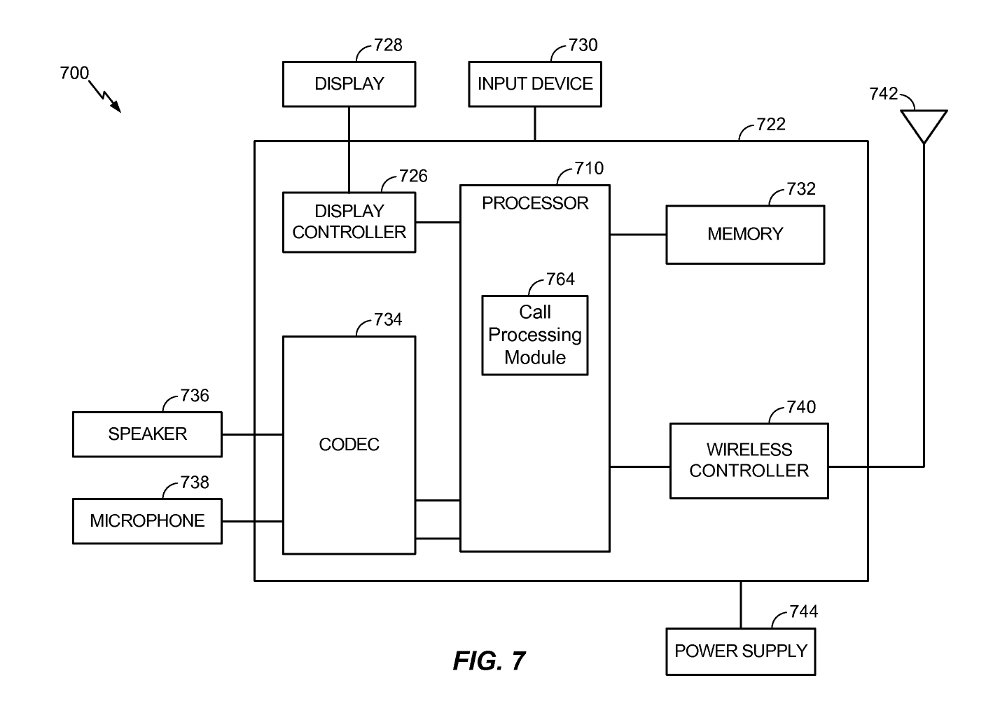

Referring to FIG. 7, a block diagram of a particular illustrative embodiment of an electronic device 700 including a call processing module 764 is shown. The device 700 includes a processor 710, such as a central processing unit (CPU), coupled to a memory 732. The processor 710 may include the call processing module 764, such as the call processing module 110 of FIG. 1. The call processing module 764 may be implemented as a hardware component of the processor 710. Alternatively, the call processing module 764 may be implemented as software (e.g., instructions stored in the memory 732 and executed by the processor 710).

FIG. 7 also shows a display controller 726 that is coupled to the processor 710 and to a display 728. The display 728 may correspond to the display 118 of FIG. 1. A coder/decoder (CODEC) 734 can also be coupled to the processor 710. A speaker 736 and a microphone 738 can be coupled to the CODEC 734. The speaker 736 may correspond to the speaker 120 and the microphone 738 may correspond to the microphone 114.

FIG. 7 also indicates that a wireless controller 740 can be coupled to the processor 710 and to an antenna 742. In a particular embodiment, the processor 710, the display controller 726, the memory 732, the CODEC 734, and the wireless controller 740 are included in a system-in-package or system-on-chip device 722. In a particular embodiment, an input device 730 and a power supply 744 are coupled to the system-on-chip device 722. The input device 730 may correspond to a touch screen interface. Moreover, in a particular embodiment, as illustrated in FIG. 7, the display 728, the input device 730, the speaker 736, the microphone 738, the antenna 742, and the power supply 744 are external to the system-on-chip device 722. However, each of the display 728, the input device 730, the speaker 736, the microphone 738, the antenna 742, and the power supply 744 can be coupled to a component of the system-on-chip device 722, such as an interface or a controller.

In conjunction with the described embodiments, an apparatus includes means for receiving audio data from a second device. The apparatus further includes means for playing audio output, the audio output derived from the audio data. The apparatus further includes means for generating media output from a source other than the second device. The apparatus further includes means for switching from playing the audio output to generating the media output while monitoring the audio data for a keyword and switching back to playing the audio output based on detecting the keyword. For example, the means for receiving audio data may include the antenna 742, the wireless controller 740, or a combination thereof. The means for playing may include the call processing module 110, the speaker 120, the display 118, the speaker 736, the display 728, or a combination thereof. The means for generating the media output may include the call processing module 110, the speaker 120, the display 118, the speaker 736, the display 728, the wireless controller 740, or a combination thereof. The means for switching may include the call processing module 110, the keyword recognizer 112, the call processing module 764, or a combination thereof.

Those of skill would further appreciate that the various illustrative logical blocks, configurations, modules, circuits, and algorithm steps described in connection with the embodiments disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary non-transitory (e.g., tangible) storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method comprising:
receiving, at a communication device, audio data from a second device;
playing audio output, the audio output derived from the audio data;
switching from playing the audio output to generating media output from a source other than the second device while monitoring the audio data for a keyword; and
switching back to playing the audio output based on detecting the keyword.

2. The method of claim 1, further comprising halting generation of the media output.

3. The method of claim 1, wherein generating the media output comprises sending a request to a third electronic device for the third electronic device to begin playback of the media output.

4. The method of claim 1, further comprising receiving a command to execute an application, wherein the application monitors the audio data.

5. The method of claim 4, wherein the application controls the generation of the media output.

6. The method of claim 1, wherein the keyword is determined based on user input.

7. The method of claim 1, wherein the keyword is determined based on a location of the second device.

8. The method of claim 1, wherein the keyword is one of a plurality of keywords for which the audio data is monitored, further comprising:
receiving input indicating an addition, a subtraction, a substitution, any other update, or a combination thereof to the plurality of keywords while monitoring the audio data; and
updating the plurality of keywords based on the input.

9. The method of claim 1, wherein the media output is determined based on a selection received from a user of the communication device.

10. The method of claim 1, wherein the source of the media output is a memory of the communication device.

11. The method of claim 1, wherein the source of the media output is a device external to the communication device.

12. The method of claim 1, wherein the media output comprises music.

13. The method of claim 1, wherein the media output is transmitted to a third device.

14. The method of claim 1, wherein the media output is output via a display interface, an audio interface, or a combination thereof.

15. An apparatus comprising:
a memory; and
a processor configured to:
receive data from a second device;
play output, the output derived from the data;
switch from playing the output to generating media output from a source other than the second device while monitoring the data for a keyword; and
switch back to playing the output based on detecting the keyword.

16. The apparatus of claim 15, wherein the processor is further configured to receive a request to monitor the data.

17. The apparatus of claim 15, wherein the keyword is determined based on a detected location of the second device.

18. The apparatus of claim 15, wherein the keyword corresponds to a default keyword.

19. The apparatus of claim 15, wherein the keyword is determined based on a language detected in the audio data.

20. The apparatus of claim 15, wherein the source of the media output is the memory.

21. A computer-readable storage device comprising instructions, which when executed by a processor cause the processor to:
receive audio data from a second device;
play audio output, the audio output derived from the audio data;
switch from playing the audio output to generating media output from a source other than the second device while monitoring the audio data for a keyword; and
switch back to playing the audio output based on detecting the keyword.

22. The computer-readable storage device of claim 21, wherein generating the media output comprises sending a request to a third electronic device for the third electronic device to begin playback of the media output.

23. The computer-readable storage device of claim 21, further comprising receiving a request to monitor the audio data for the keyword.

24. The computer-readable storage device of claim 21, wherein the media output corresponds to a web browser application, a video, music, a camera application, an e-mail client, a text messaging application, or a combination thereof.

25. The computer-readable storage device of claim 21, wherein the keyword is “hello.”

26. The computer-readable storage device of claim 21, wherein the keyword is determined based on user input.

27. The computer-readable storage device of claim 21, wherein the media output is determined based on a selection received from a user.

28. An apparatus comprising:
means for receiving audio data from a second device;
means for playing audio output, the audio output derived from the audio data;
means for generating media output from a source other than the second device; and
means for switching from playing the audio output to generating the media output while monitoring the audio data for a keyword and switching back to playing the audio output based on detecting the keyword.

29. The apparatus of claim 28, wherein generating the media output comprises sending a request to a third electronic device for the third electronic device to begin playback of the media output.

30. The apparatus of claim 28, wherein the media output is determined based on user activity prior to receiving the audio data from the second device.
